(19) United States
(12) Patent Application Publication
(10) Pub. No.: US 2026/0162673 A1
(43) Pub. Date: Jun. 11, 2026

(54) ELECTRONIC DEVICE AND METHOD FOR DETECTING SPEECH RATE

(71) Applicant: Realtek Semiconductor Corporation, Hsinchu (TW)

(72) Inventor: Ying-Ying CHAO, Hsinchu (TW)

(21) Appl. No.: 19/402,992

(22) Filed: Nov. 27, 2025

(30) Foreign Application Priority Data
Dec. 10, 2024 (TW) 113147776

(51) Int. Cl. G10L 25/78; G10L 25/45; G10L 25/93

(52) U.S. Cl. CPC G10L 25/78; G10L 25/45; G10L 25/93; G10L 2025/783

(57) ABSTRACT

A method for detecting a speech rate is disclosed. The method for detecting the speech rate includes: obtaining a digital audio signal; acquiring a plurality of audio frames from the digital audio signal and setting an observation window that includes a plurality of first audio frames in the audio frames; determining whether the observation window belongs to speech or not; if the observation window belongs to speech, performing a local peak detection on the first audio frames; accumulating a syllable count if the local peak detection shows that the first audio frames include a discontinuous peak; and calculating the speech rate based on the syllable count.

### RELATED APPLICATIONS

This application claims priority to Taiwan Application Serial Number 113147776, filed Dec. 10, 2024, which is herein incorporated by reference.

### BACKGROUND

### Field of Invention

The present disclosure relates to a method and an electronic device for detecting a speech rate with low power consumption and low latency.

### Description of Related Art

In recent years, many intelligent systems have been developed and applied based on the speech rate. For example, customer service systems can use speech rate to judge the speaker's emotions so as to improve services (e.g., the customer service systems can automatically transfer the service to patient customer service personnel). For another example, smart medical systems can be used speech rate to judge the physiological condition of the elderly people so as to assess their health state. The common method for measuring the speech rate is to convert a speech file into a text file, and then calculate the total number of words spoken within a certain length of time. However, this common method requires more computation amount. In addition, calculating the total number of words spoken does not mean the number of syllables. For example, a single word in English usually has multiple syllables. Even in the same language, the number of syllables included in one word may be different from the number of syllables included in another word. In different languages, the same number of words may give different perceptions of speech rate, so the result obtained from using the number of words as the base unit for calculation differs from the listener's experience.

For the foregoing reasons, there is a need to develop an electronic device and a method for detecting a speech rate to resolve the above-mentioned problems.

### SUMMARY

The present disclosure provides an electronic device for detecting a speech rate. The electronic device includes a memory and a processor. The memory is configured for storing a plurality of instructions. The processor is communicatively connected to the memory and configured for executing the instructions to complete following procedures. These procedures include: obtaining a digital audio signal; acquiring a plurality of audio frames from the digital audio signal and setting an observation window, in which the observation window includes a plurality of first audio frames in the audio frames; determining whether the observation window belongs to speech or not; performing a local peak detection on the first audio frames if the observation window belongs to speech; accumulating a syllable count if the local peak detection shows that the first audio frames include a discontinuous peak; and calculating the speech rate based on the syllable count.

The present disclosure further provides a method for detecting a speech rate executed by the electronic device. The method includes: obtaining a digital audio signal; acquiring a plurality of audio frames from the digital audio signal and setting an observation window, in which the observation window includes a plurality of first audio frames in the audio frames; determining whether the observation window belongs to speech or not; performing a local peak detection on the first audio frames if the observation window belongs to speech; accumulating a syllable count if the local peak detection shows that the first audio frames include a discontinuous peak; and calculating the speech rate based on the syllable count.

By using the above electronic device and method for detecting the speech rate, the number of syllables can be calculated with less computation amount.

It is to be understood that both the foregoing general description and the following detailed description are by examples, and are intended to provide further explanation of the disclosure as claimed.

### BRIEF DESCRIPTION OF THE DRAWINGS

The accompanying drawings are included to provide a further understanding of the present disclosure, and are incorporated in and constitute a part of this specification. The drawings illustrate embodiments of the present disclosure and, together with the description, serve to explain the principles of the present disclosure.

FIG. 1 depicts schematic diagram of an electronic device for detecting a speech rate according to one embodiment of the present disclosure.

FIG. 2 depicts a flowchart of a method for detecting the speech rate according to one embodiment of the present disclosure.

FIG. 3 depicts a schematic diagram of acquiring audio frames according to one embodiment of the present disclosure.

FIG. 4 depicts a flowchart of a voice activity detection according to one embodiment of the present disclosure.

FIG. 5 depicts a flowchart of a local peak detection according to one embodiment of the present disclosure.

FIG. 6 depicts a flowchart of determining whether there is a syllable or not according to one embodiment of the present disclosure.

FIG. 7 depicts a schematic diagram of experimental results according to one embodiment of the present disclosure.

### DESCRIPTION OF THE EMBODIMENTS

Reference will now be made in detail to the present embodiments of the disclosure, examples of which are illustrated in the accompanying drawings. Wherever possible, the same reference numbers are used in the drawings and the description to refer to the same or like parts.

The using of “first”, “second”, etc. in the specification should be understood for identify units or data described by the same terminology, but are not referred to particular order or sequence.

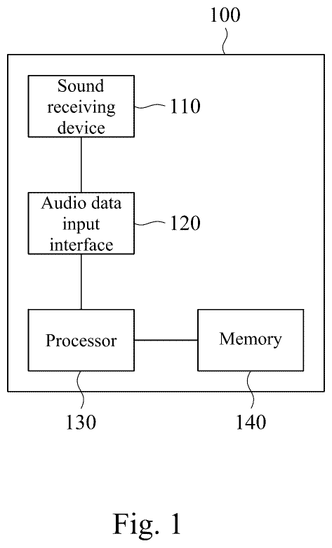

FIG. 1 depicts schematic diagram of an electronic device 100 for detecting a speech rate according to one embodiment of the present disclosure. A description is provided with reference to FIG. 1. The electronic device 100 may be implemented as a smart watch, smart glasses, a smart pin, a smart phone, a telephone, an embedded system, or other electronic device with computing capability. The electronic device 100 includes a sound receiving device 110, an audio data input interface 120, a processor 130, and a memory 140. The sound receiving device 110 is, for example, a microphone or an array microphone for capturing an analog audio signal. The audio data input interface 120 is electrically connected to the sound receiving device 110, and includes an analog-to-digital converter to convert the analog audio signal into a digital audio signal. The processor 130 is electrically connected to the audio data input interface 120 to obtain the digital audio signal from the audio data input interface 120. The processor 130 is, for example, a central processing unit (CPU), a microprocessor, a microcontroller, a digital signal processor (DSP), or an application-specific integrated circuit (ASIC). The memory 140 is electrically connected to the processor 130. The memory 140 is, for example, a random access memory (RAM), a read-only memory (ROM), a flash memory, a hard disk, or a flash drive. A plurality of instructions are stored in the memory 140. The processor 130 can execute these instructions to complete a method for detecting the speech rate. In other embodiments, the processor 130 can obtain the digital audio signal from some other device, some other interface, or some other storage device. In such embodiments, the sound receiving device 110 and the audio data input interface 120 may be not necessary.

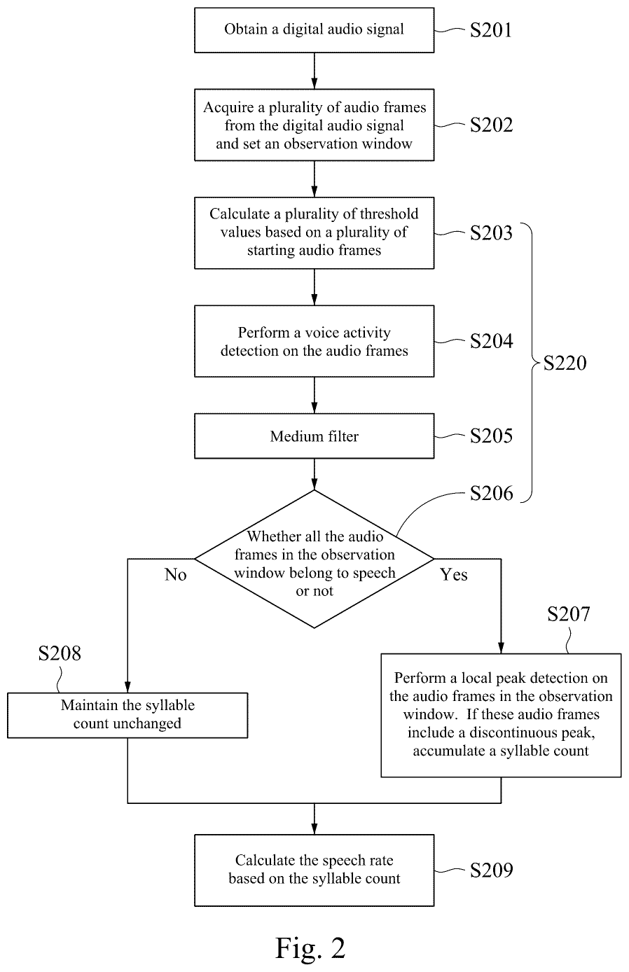

FIG. 2 depicts a flowchart of the method for detecting the speech rate according to one embodiment of the present disclosure. A description is provided with reference to FIG. 2. In Step S201, a digital audio signal is obtained. As mentioned above, the digital audio signal may be obtained through the sound receiving device 110 and the audio data input interface 120, or may be obtained from some other device, some other interface, or some other storage device.

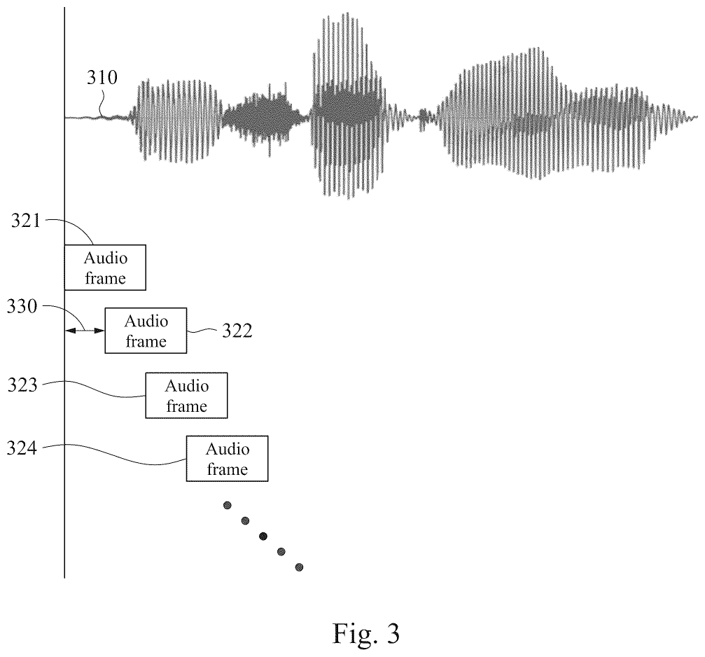

In Step S202, a plurality of audio frames are acquired from the digital audio signal and an observation window is set. FIG. 3 depicts a schematic diagram of acquiring the audio frames 321˜324 according to one embodiment of the present disclosure. A digital audio signal 310 is depicted in FIG. 3. The horizontal axis of FIG. 3 represents time and the vertical axis of FIG. 3 represents amplitude (that is, energy) of the digital audio signal 310. Here, an audio frame is captured every hop interval 330. In this method, the audio frames 321˜324 are acquired in sequence, in which two adjacent audio frames are partially overlapped. For example, the sample rate can be set to 16000 Hz, 24000 Hz, 44100 Hz, or 48000 Hz, but the present disclosure is not limited thereto. In this example, the sample rate is 48000 Hz. It is assumed that a frame size of the audio frame is 0.02 seconds, which means each audio frame has 0.02*48000=960 sample points. In addition, the overlapped frame size between two adjacent audio frames is 0.01 seconds, that is, 0.01*48000=480 sample points are overlapped. This means that the hop interval 330 has 960−480=480 sample points. The above numerical values are only examples, and the present disclosure does not limit the sample rate, the audio frame length, and the size of the hop interval.

Additionally, each observation window includes d audio frames, in which d is a positive integer greater than 1. The observation window is a sliding window, for example, the sliding window slides one audio frame each time. The method for detecting the speech rate according to the present disclosure uses the observation window as a processing unit. In the present embodiment, the positive integer d is an odd number, such as 7, but the present disclosure does not limit the value of the positive integer d. In other embodiments, the positive integer d may be an even number. When one observation window includes d audio frames, this means that it is required to wait until all the d audio frames are received before subsequent processing, and this also means that there is a delay of (d−1)*h/sr, where h is the hop interval, sr is the sample rate. For example, when d=7, there will be a delay of (7−1)*480/48000=0.06 seconds.

A description is provided with reference to FIG. 2. In Step S203, a plurality of threshold values are calculated based on a plurality of starting audio frames. Here, it is assumed that the first t seconds of the digital audio signal correspond to ambient sound, where t is a real number, for example, 0.1 seconds. Therefore, there are 0.1*48000=4800 sample points to be ambient sound, and the audio frames within this period are the starting audio frames. In this example, there are 4800/480=10 starting audio frames in total, but the present disclosure is not limited thereto. Next, a zero-crossing rate, an audio frame energy, and a speech energy of each of the starting audio frames are calculated. It is assumed that fₙ represents an nth audio frame, an amplitude of a sample point in this audio frame fₙ is represented by x[i], where n and i are positive integers, and then the zero-crossing rate is calculated as shown in the following mathematical formulae 1 and 2.

$${x}^{′} [ i ] = \{ \begin{matrix}1 , & if x [ i ] > 0 \\ - 1 , & if x [ i ] \leq 0\end{matrix} ; \qquad Mathematical Formula 1$$

$$ZCR ( {f}_{n} ) = {\sum }_{i} \frac{{x}^{′} [ i + 1 ] - {x}^{′} [ i ]}{2 \times frame size} . \qquad Mathematical formula 2$$

Here ZCR(fₙ) is the zero-crossing rate, and frame size indicates a number of sample points included in one audio frame. In addition to that, in order to calculate the audio frame energy and the speech energy, the audio frame needs to be converted from the spatial domain into the frequency domain, and then the sum of all energies is obtained as the audio frame energy, which can be expressed by the following mathematical formulae 3 and 4.

$$y [ k ] = fft ( x ) , k = 0 ∼ ( \frac{sr}{2} ) Hz ; \qquad Mathematical formula 3$$

$$E ( {f}_{n} ) = sum ( {\vert y [ k ] \vert}^{2} ) . \qquad Mathematical formula 4$$

Here k represents frequency, y[k] represents the coefficient corresponding to frequency k, fft( ) is Fast Fourier transform, sr is the sample rate, and E(fₙ) is the audio frame energy of the audio frame fₙ. In addition, the speech energy is calculated according to the following mathematical formula 5.

$$V ( {f}_{n} ) = sum ( {\vert y [ k ] \vert}^{2} ) , k = 300 ∼ 3000 Hz . \qquad Mathematical formula 5$$

Here V(fₙ) is the speech energy of the audio frame fₙ. Here, the frequency k in the range of 300˜3000 Hz is used to calculate the speech energy V(fₙ). However, in other embodiments, the frequency k in the range of 100˜3000 Hz or in other ranges may be used to calculate the speech energy V(fₙ). The present disclosure is not limited to the above embodiments. The speech energy ratio can be obtained by dividing the speech energy by the audio frame energy, as shown in the following mathematical formula 6.

$$R ( {f}_{n} ) = \frac{V ( {f}_{n} )}{E ( {f}_{n} )} . \qquad Mathematical formula 6$$

Here R(fₙ) is the speech energy ratio of the audio frame fₙ. Next, an average value of the zero-crossing rates of the above plurality of starting audio frames is calculated to serve as a zero-crossing rate threshold value (hereinafter represented as ZCR_T). An average value of the speech energies of the starting audio frames is calculated to serve as a speech energy threshold value (hereinafter represented as SE_T), and an average value of the speech energy ratios of the starting audio frames is calculated to serve as a speech ratio threshold value (hereinafter represented as SR_T).

In Step S204, a voice activity detection (VAD) is performed on the audio frames. All the audio frames are processed by the same voice activity detection. Here, the audio frames in the observation window (also called first audio frames) are taken as an example for illustration. First, for the first audio frame fₙ, the zero-crossing rate ZCR(fₙ), the speech energy V(fₙ), and the speech energy ratio R(fₙ) of this first audio frame fₙ are calculated. These calculations can respectively refer to the above mathematical formulae 2, 5, and 6. Additionally, a speech energy decibel L(fₙ) is calculated based on the speech energy V(fₙ) and the speech energy threshold value SE_T, as shown in the following mathematical formula 7. The speech energy decibel L(fₙ) refers to a ratio of the speech energy of a current audio signal to the speech energy of the ambient sound. The larger the value of the speech energy decibel is, the clearer the speech part in the current audio signal is.

$$L ( {f}_{n} ) = 10 \times {log}_{10} \frac{V ( {f}_{n} )}{SE\_T} . \qquad Mathematical formula 7$$

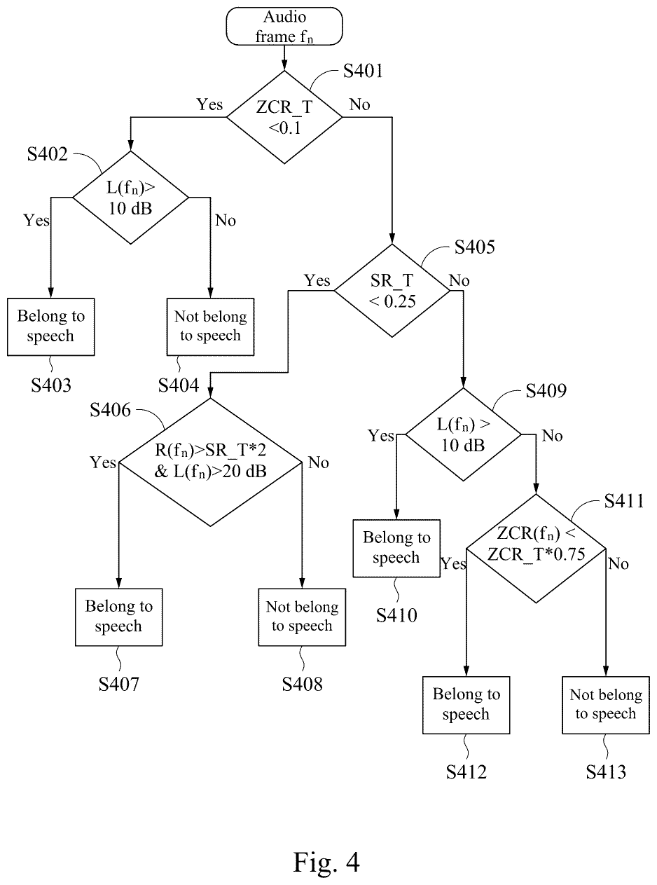

Then, a description is provided with reference to FIG. 4. FIG. 4 depicts a flowchart of a voice activity detection according to one embodiment of the present disclosure. This flow of FIG. 4 is used to determine whether the audio frame fₙ belongs to speech or not. In Step S401, it is determined whether the zero-crossing rate threshold value ZCR_T is less than a first value (such as 0.1) or not. If the determined result of Step S401 is yes, it means that noises in the ambient sound are smaller, and Step S402 is performed to determine whether the speech energy decibel L(fₙ) is greater than a second value (such as 10 dB) or not. If the zero-crossing rate threshold value ZCR_T is less than the first value and the speech energy decibel L(fₙ) is greater than the second value, Step S403 is performed to determine that the corresponding audio frame fₙ belongs to speech. If the zero-crossing rate threshold value ZCR_T is less than the first value and the speech energy decibel L(fₙ) is less than or equal to the second value, Step S404 is performed to determine that the corresponding audio frame fₙ does not belong to speech.

If the zero-crossing rate threshold value ZCR_T is greater than or equal to the first value, it means that there is a certain degree of noise in the ambient sound, and it is necessary to further determine how many components of the ambient sound fall within the voice band, that is, Step S405 is performed to determine whether the speech ratio threshold value SR_T is less than a third value (such as 0.25) or not. If the determined result of Step S405 is yes, it means that less components of the ambient sound fall within the voice band, and more components of the ambient sound fall within the voice band with high frequency. Therefore, the speech energy in the audio signal can be used to determine whether the corresponding audio frame fₙ belongs to speech or not. Specifically, if the determined result of Step S405 is yes, Step S406 is performed to determine whether the speech energy ratio R(fₙ) is greater than a product of the speech ratio threshold value SR_T and a fourth value (such as 2) and the speech energy decibel L(fₙ) is greater than a fifth value (such as 20 dB) or not. If the determined result of Step S406 is yes, Step S407 is performed to determine that the corresponding audio frame fₙ belongs to speech. Otherwise (if the determined result of Step S406 is no), Step S408 is performed to determine that the corresponding audio frame fₙ does not belong to speech.

If the determined result of Step S405 is no, it means that the ambient sound includes a lot of energy fall within the voice band. Not only the speech energy in the audio signal is needed to determine whether the corresponding audio frame fₙ belongs to speech or not, but also information of the zero-crossing rate is needed to determine whether the corresponding audio frame fₙ belongs to speech or not. Specifically, if the determined result of Step S405 is no, Step S409 is performed to determine whether the speech energy decibel L(fₙ) is greater than a sixth value (such as 10 dB) or not. If the determined result of Step S409 is yes, Step S410 is performed to determine that the corresponding audio frame fₙ belongs to speech. If the determined result of Step S409 is no, Step S411 is performed to determine whether the zero-crossing rate ZCR(fₙ) is less than a product of the zero-crossing rate threshold value ZCR_T and a seventh value (such as 0.75) or not. If the determined result of Step S411 is yes, Step S412 is performed to determine that the corresponding audio frame fₙ belongs to speech. Otherwise, if the determined result of Step S411 is no, Step S413 is performed to determine that the corresponding audio frame fₙ does not belong to speech.

The first to seventh values mentioned above are only examples, and the present disclosure does not limit their numerical values. In some embodiments, the sixth value (used in Step S409, for example, 10 dB) is smaller than the fifth value (used in Step S406, for example, 20 dB). This is because that the ambient sound of Step S409 includes more energy that belongs to the voice band, which makes the real speech component within the ambient sound less obvious, so it is necessary to lower the threshold for determining that the corresponding audio frame belongs to speech. In addition to that, the second value (used in Step S402, for example, 10 dB) is smaller than the fifth value. This is because that, in Step S402, there are fewer noises within the ambient sound, so only a little speech energy is necessary to determine that the corresponding audio frame belongs to speech. In addition, in the flow of FIG. 4, the speech energy decibel L(fₙ), the speech energy ratio R(fₙ), and the speech energy V(fₙ) can be replaced by one another. For example, the speech energy ratio R(fₙ) can be used in step S402 to replace the speech energy decibel L(fₙ), and the second value can be adjusted correspondingly after replacement, and so on.

With additional reference to FIG. 2. After determining whether each of the audio frames in the observation window belongs to speech or not, a plurality of speech indication values can be obtained. For example, a speech indication value of “1” is used to indicate that it belongs to speech, and a speech indication value of “0” is used to indicate that it does not belong to speech. After Step S204, Step S205 is performed to apply a medium filter to these speech indication values to make the speech determination smoother. For example, if there are 7 audio frames in the observation window, the medium filter is applied to the middle audio frame (that is, the 4th audio frame). If the 4th audio frame does not belong to speech (the speech indication value is “0”) but there are more than 4 audio frames in the observation window that belong to speech, then the 4th audio frame will be modified to belong to speech after filtering by the medium filter (the speech indication value of the 4th audio frame is modified to “1”). Those skilled in the art should be able to understand the medium filter, and a description in this regard is not provided here.

After the medium filter is applied, Step S206 is performed to determine whether all the audio frames in the observation window belong to speech or not, that is, Step S206 is performed to determine whether all the corresponding speech indication values in the observation window are the value “1” or not. For example, if all the speech indication values indicate that all the audio frames in the observation window belong to speech, it is determined that the observation window belongs to speech. Steps S203 to S206 may be combined into and called Step S220, and the Step S220 is to determine whether the observation window belongs to speech or not. However, Step S220 may be implemented in different ways, and the present disclosure is not limited that Step S220 is implemented by Steps S203 to S206. For example, in other embodiments, Step S205 may be omitted for Step S220, or some other low-pass filter may be adopted for Step S220. In some embodiments, other voice activity detection may be used, such as calculating a Mel-Frequency Cepstrum (MFC) or inputting the audio frames into a machine learning model to determine whether the audio frames belong to speech or not. In some embodiments, a Gaussian Mixture Model (GMM) may be used to detect the background pat of the audio signal to further set relevant threshold values.

If the determined result of Step S206 is yes, Step S207 is performed to perform a local peak detection on the audio frames in the observation window. If the local peak detection shows that these audio frames include a discontinuous peak, a syllable count is accumulated. Since one syllable usually represents an energy peak in the audio signal, potential syllables can be detected through the local peak detection. Additionally, whether a peak value is continuous or not can be used to help detect whether this syllable is a real syllable or not to further calculate a number of syllables (that is, the syllable count) in the digital audio signal. In addition to that, if the determined result of Step S206 is no, it means that the observation window does not belong to speech, and the syllable count is maintained unchanged in Step S208. Finally, in Step S209, the speech rate is calculated based on the syllable count, in which a larger syllable count means that a passage of audio signal includes more syllables, and therefore the speech rate is higher. Steps S207 and S209 are described in detail below.

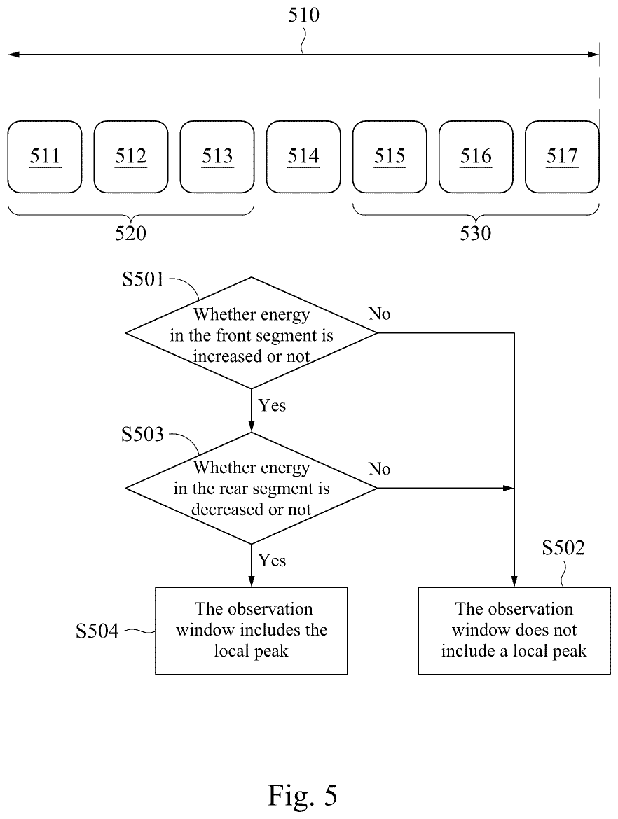

FIG. 5 depicts a flowchart of the local peak detection according to one embodiment of the present disclosure. A description is provided with reference to FIG. 5. FIG. 5 depicts an observation window 510, which includes audio frames 511˜517. First, these audio frames 511˜517 are divided into a front segment 520 and a rear segment 530. In this example, the middle audio frame 514 of the audio frames 511˜517 is used as a reference, the audio frames 511˜513 before the middle audio frame 514 are set as the front segment 520, and the audio frames 515˜517 after the middle audio frame 514 are set as the rear segment 530. From another perspective, the observation window 510 includes d audio frames, d is an odd number (such as 7), in which the p-th=(d+1)/2=4th audio frame is the middle audio frame, 1st to (p−1)-th audio frames are set as the front segment, and (p+1)-th to d-th audio frames are set as the rear segment. Step S501 is performed to determine whether energy in the front segment is increased or not, that is, energy of the audio frame 512 is higher than energy of the audio frame 511, and energy of the audio frame 513 is higher than the energy of the audio frame 512. If the determined result of Step S501 is no, Step S502 is performed to determine that the observation window does not include a local peak. If the determined result of Step S501 is yes, Step S503 is performed to determine whether energy in the back segment is decreased or not, that is, energy of the audio frame 516 is lower than energy of the audio frame 515, and energy of the audio frame 517 is lower than the energy of the audio frame 516. If the determined result of Step S503 is yes, Step S504 is performed to determine that the observation window includes the local peak.

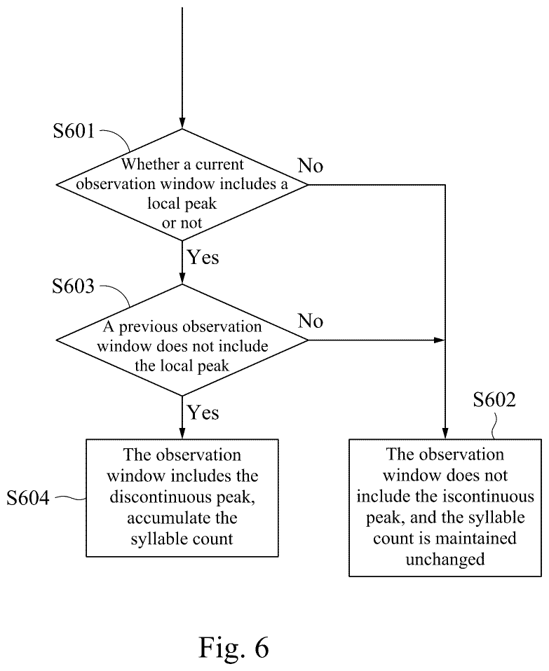

FIG. 6 depicts a flowchart of determining whether there is a syllable or not according to one embodiment of the present disclosure. A description is provided with reference to FIG. 2 and FIG. 6. In some embodiments, Step S207 includes steps S601˜S604. Step S601 is performed to determine whether a current observation window includes a local peak or not. The details of Step S601 can refer to FIG. 5. If the determined result of Step S601 is no, Step S602 is performed to determine that the observation window does not include the discontinuous peak, and the syllable count is maintained unchanged. If the determined result of Step S601 is yes, Step S603 is performed to determine whether a previous observation window does not include the local peak or not. There is a distance of one audio frame between the previous observation window and the current observation window. For example, the current observation window includes the audio frames fₙ₋₆˜fₙ, and the previous observation window preceding the current observation window includes the audio frames fₙ₋₇˜fₙ₋₁. The judgment of FIG. 5 is applicable to both the current observation window and the previous observation window. If the determined result of Step S603 is no, Step S602 is performed. If the determined result of Step S603 is yes, Step S604 is performed to determine that the observation window includes the discontinuous peak, which means that the observation window includes the syllable, so the syllable count is accumulated (for example, the syllable count+1).

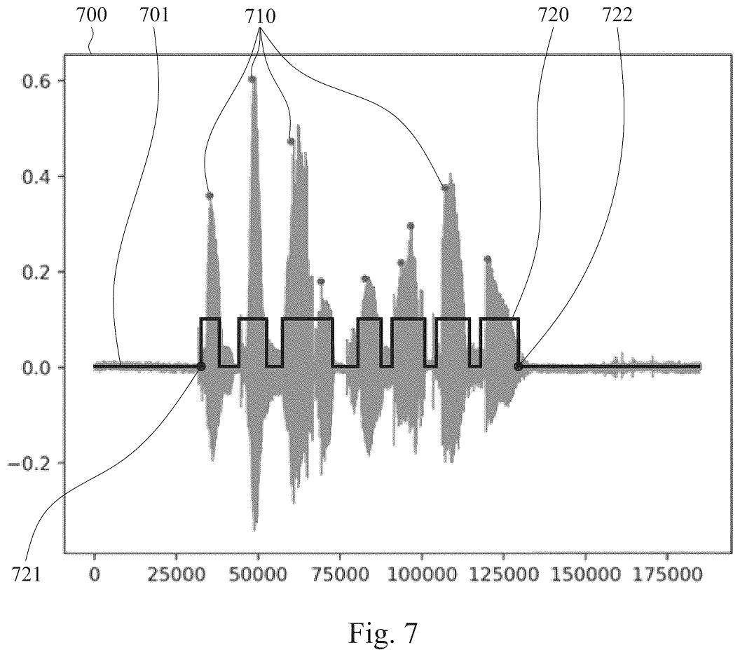

FIG. 7 depicts a schematic diagram of experimental results according to one embodiment of the present disclosure. A description is provided with reference to FIG. 7, which shows a digital audio signal 701. The horizontal axis of FIG. 7 represents sample points, and the vertical axis of FIG. 7 represents an amplitude of the digital audio signal 701. After determining whether all observation windows include syllables or not, a plurality of syllables 710 can be detected. In addition, after determining whether all audio frames belong to speech or not (and after filtering by the medium filter), a curve 720 can be generated, in which the curve 720 has two levels, a high level represents that a corresponding audio frame belongs to speech, and a low level represents that the corresponding audio frame does not belong to speech. Since people may pause when speaking, a passage belonging to speech will not be continuous. Here, a total length of speech (the unit of the total length of speech can be sample points, number of audio frames, or number of seconds) between a first audio frame 721 belonging to speech of all audio frames and a last audio frame 722 belonging to speech of all the audio frames can be calculated. Then, a ratio of the above-mentioned syllable count to the total length of speech is calculated as the speech rate. For example, if the unit of the total length of speech is number of seconds, then the speech rate represents a number of syllables per second.

The disclosured method for detecting the speech rate does not need to convert the speech file into the text file, so the computation amount and power consumption are lower than the common method, which is applicable to an embedded system. Additionally, the disclosed method counts the number of syllables, so the disclosed method is applicable to different languages, thereby providing an objective speech rate for reference.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure covers modifications and variations of this disclosure provided they fall within the scope of the following claims and their equivalents.

What is claimed is:

1. An electronic device for detecting a speech rate, comprising:
a memory configured for storing a plurality of instructions; and
a processor communicatively connected to the memory and configured for executing the plurality of instructions to complete following procedures:
obtaining a digital audio signal;
acquiring a plurality of audio frames from the digital audio signal and setting an observation window, wherein the observation window comprises a plurality of first audio frames in the plurality of audio frames;
determining whether the observation window belongs to speech or not;
performing a local peak detection on the plurality of first audio frames if the observation window belongs to speech;
accumulating a syllable count if the local peak detection shows that the plurality of first audio frames comprise a discontinuous peak; and
calculating the speech rate based on the syllable count.

2. The electronic device of claim 1, wherein steps of determining whether the observation window belongs to speech or not comprise:
acquiring a plurality of starting audio frames in the plurality of audio frames;
calculating an average value of a plurality of zero-crossing rates of the plurality of starting audio frames to serve as a zero-crossing rate threshold value;
calculating a plurality of audio frame energies of the plurality of starting audio frames;
calculating a plurality of speech energies of the plurality of starting audio frames;
calculating an average value of the plurality of speech energies to serve as a speech energy threshold value; and
calculating a plurality of speech energy ratios based on the plurality of speech energies and the plurality of audio frame energies, and calculating an average value of the plurality of speech energy ratios to serve as a speech ratio threshold value.

3. The electronic device of claim 2, wherein the steps of determining whether the observation window belongs to speech or not further comprise:
calculating a first speech energy, a first zero-crossing rate, and a first speech energy ratio of one of the plurality of first audio frames;
calculating a speech energy decibel based on the first speech energy and the speech energy threshold value;
determining that the one of the plurality of first audio frames belongs to speech if the zero-crossing rate threshold value is less than a first value and the speech energy decibel is greater than a second value; and
determining that the one of the plurality of first audio frames does not belong to speech if the zero-crossing rate threshold value is less than the first value and the speech energy decibel is less than or equal to the second value.

4. The electronic device of claim 3, wherein the steps of determining whether the observation window belongs to speech or not further comprise:
determining whether the speech ratio threshold value is less than a third value or not if the zero-crossing rate threshold value is greater than or equal to the first value;
determining whether the first speech energy ratio is greater than a product of the speech ratio threshold value and a fourth value and the speech energy decibel is greater than a fifth value or not, if the speech ratio threshold value is less than the third value;
determining that the one of the plurality of first audio frames belongs to speech, if the first speech energy ratio is greater than the product of the speech ratio threshold value and the fourth value and the speech energy decibel is greater than the fifth value; and
determining that the one of the plurality of first audio frames does not belong to speech if the first speech energy ratio is not greater than the product of the speech ratio threshold value and the fourth value or the speech energy decibel is not greater than the fifth value.

5. The electronic device of claim 4, wherein the steps of determining whether the observation window belongs to speech or not further comprise:
determining whether the speech energy decibel is greater than a sixth value or not if the speech ratio threshold value is greater than or equal to the third value; and
determining that the one of the plurality of first audio frames belongs to speech if the speech energy decibel is greater than the sixth value.

6. The electronic device of claim 5, wherein the steps of determining whether the observation window belongs to speech or not further comprise:
determining whether the first zero-crossing rate is less than a product of the zero-crossing rate threshold value and a seventh value or not if the speech energy decibel is less than or equal to the sixth value;
determining that the one of the plurality of first audio frames belongs to speech if the first zero-crossing rate is less than the product of the zero-crossing rate threshold value and the seventh value; and
determining that the one of the plurality of first audio frames does not belong to speech if the first zero-crossing rate is not less than the product of the zero-crossing rate threshold value and the seventh value.

7. The electronic device of claim 6, wherein the steps of determining whether the observation window belongs to speech or not further comprise:
determining whether each of the plurality of first audio frames belongs to speech or not to obtain a plurality of speech indication values;
applying a medium filter to filter the plurality of speech indication values; and
determining that the observation window belongs to speech if all the plurality of speech indication values represent belonging to speech after the medium filter is applied.

8. The electronic device of claim 1, wherein the local peak detection comprises:
dividing the plurality of first audio frames into a front segment and a rear segment;
determining whether an energy in the front segment is increased and an energy in the rear segment is decreased or not; and
determining that the observation window comprises a local peak if the energy in the front segment is increased and the energy in the rear segment is decreased.

9. The electronic device of claim 8, wherein the procedures further comprise:
determining that the plurality of first audio frames comprise the discontinuous peak if the observation window comprises the local peak and a previous observation window preceding the observation window does not comprise the local peak.

10. The electronic device of claim 1, wherein the procedures further comprise:
determining whether the plurality of audio frames belong to speech or not; and
calculating a total length of speech between a first one of the plurality of audio frames belonging to speech and a last one of the plurality of audio frames belonging to speech;
wherein step of calculating the speech rate based on the syllable count comprises:
calculating a ratio of the syllable count to the total length of speech as the speech rate.

11. A method for detecting a speech rate executed by an electronic device, comprising:
obtaining a digital audio signal;
acquiring a plurality of audio frames from the digital audio signal and setting an observation window, wherein the observation window comprises a plurality of first audio frames in the plurality of audio frames;
determining whether the observation window belongs to speech or not;
performing a local peak detection on the plurality of first audio frames if the observation window belongs to speech;
accumulating a syllable count if the local peak detection shows that the plurality of first audio frames comprise a discontinuous peak; and
calculating the speech rate based on the syllable count.

12. The method for detecting the speech rate of claim 11, wherein steps of determining whether the observation window belongs to speech or not comprise:
acquiring a plurality of starting audio frames in the plurality of audio frames;
calculating an average value of a plurality of zero-crossing rates of the plurality of starting audio frames to serve as a zero-crossing rate threshold value;
calculating a plurality of audio frame energies of the plurality of starting audio frames;
calculating a plurality of speech energies of the plurality of starting audio frames;
calculating an average value of the plurality of speech energies to serve as a speech energy threshold value; and
calculating a plurality of speech energy ratios based on the plurality of speech energies and the plurality of audio frame energies, and calculating an average value of the plurality of speech energy ratios to serve as a speech ratio threshold value.

13. The method for detecting the speech rate of claim 12, wherein the steps of determining whether the observation window belongs to speech or not further comprise:
calculating a first speech energy, a first zero-crossing rate, and a first speech energy ratio of one of the plurality of first audio frames;
calculating a speech energy decibel based on the first speech energy and the speech energy threshold value;
determining that the one of the plurality of first audio frames belongs to speech if the zero-crossing rate threshold value is less than a first value and the speech energy decibel is greater than a second value; and
determining that the one of the plurality of first audio frames does not belong to speech if the zero-crossing rate threshold value is less than the first value and the speech energy decibel is less than or equal to the second value.

14. The method for detecting the speech rate of claim 13, wherein the steps of determining whether the observation window belongs to speech or not further comprise:
determining whether the speech ratio threshold value is less than a third value or not if the zero-crossing rate threshold value is greater than or equal to the first value;
determining whether the first speech energy ratio is greater than a product of the speech ratio threshold value and a fourth value and the speech energy decibel is greater than a fifth value or not if the speech ratio threshold value is less than the third value;
determining that the one of the plurality of first audio frames belongs to speech if the first speech energy ratio is greater than the product of the speech ratio threshold value and the fourth value and the speech energy decibel is greater than the fifth value; and
determining that the one of the plurality of first audio frames does not belong to speech if the first speech energy ratio is greater than the product of the speech ratio threshold value and the fourth value or the speech energy decibel is greater than the fifth value.

15. The method for detecting the speech rate of claim 14, wherein the steps of determining whether the observation window belongs to speech or not further comprise:
determining whether the speech energy decibel is greater than a sixth value or not if the speech ratio threshold value is greater than or equal to the third value; and
determining that the one of the plurality of first audio frames belongs to speech if the speech energy decibel is greater than the sixth value.

16. The method for detecting the speech rate of claim 15, wherein the steps of determining whether the observation window belongs to speech or not further comprise:
determining whether the first zero-crossing rate is less than a product of the zero-crossing rate threshold value and a seventh value or not if the speech energy decibel is less than or equal to the sixth value;
determining that the one of the plurality of first audio frames belongs to speech if the first zero-crossing rate is less than the product of the zero-crossing rate threshold value and the seventh value; and
determining that the one of the plurality of first audio frames does not belong to speech if the first zero-crossing rate is not less than the product of the zero-crossing rate threshold value and the seventh value.

17. The method for detecting the speech rate of claim 16, wherein the steps of determining whether the observation window belongs to speech or not further comprise:
determining whether each of the plurality of first audio frames belongs to speech or not to obtain a plurality of speech indication values;
applying a medium filter to filter the plurality of speech indication values; and
determining that the observation window belongs to speech if all the plurality of speech indication values represent belonging to speech after the medium filter is applied.

18. The method for detecting the speech rate of claim 11, wherein the local peak detection comprises:
dividing the plurality of first audio frames into a front segment and a rear segment;
determining whether an energy in the front segment is increased and an energy in the rear segment is decreased or not; and
determining that the observation window comprises a local peak if the energy in the front segment is increased and the energy in the rear segment is decreased.

19. The method for detecting the speech rate of claim 18, further comprising:
determining that the plurality of first audio frames comprise the discontinuous peak if the observation window comprises the local peak and a previous observation window preceding the observation window does not comprise the local peak.

20. The method for detecting the speech rate of claim 11, further comprising:
determining whether the plurality of audio frames belong to speech or not; and
calculating a total length of speech between a first one of the plurality of audio frames belonging to speech and a last one of the plurality of audio frames belonging to speech;
wherein step of calculating the speech rate based on the syllable count comprises:
calculating a ratio of the syllable count to the total length of speech as the speech rate.
